(19) United States
(12) Patent Application Publication
(10) Pub. No.: US 2019/0190857 A1
(43) Pub. Date: Jun. 20, 2019

(54) SNAPSHOTS BUFFERING SERVICE

(71) Applicant: Complete Innovations Inc., Toronto (CA)

(72) Inventors: Wei Zhou, Markham (CA); Aleksandar Damjanoski, Richmond Hill (CA); Pantelis Chatzinikolis, Toronto (CA); Tony Lourakis, Toronto (CA)

(73) Assignee: Complete Innovations inc., Toronto (CA)

(21) Appl. No.: 15/843,383

(22) Filed: Dec. 15, 2017

(51) Int. Cl. H04L 12/861; H04L 29/08

(52) U.S. Cl. CPC H04L 49/9057; H04L 67/10

(57) ABSTRACT

A method of storing telemetry data in a telemetry monitoring device comprises receiving, by a buffer insertion module, a first multiple event data from a first external device. Extracting a first event message from the first multiple event data. Storing, by the buffer insertion module, the first event message into a buffer. Receiving within a predetermined period, a second multiple event data from a second external device. Extracting, by the buffer insertion module, a second event message from the second multiple event data. Storing, by the buffer insertion module, the second event message into the buffer and determining that the second event message occurred before the first event message. Receiving, by the buffer processor, the second event message, and transmitting the second event message to a second downstream processor. Then receiving, by the buffer processor, the first event message, and transmitting the first event message to a first downstream processor.

### BACKGROUND OF THE INVENTION

### Field of the Invention

The present invention relates to real-time event handling and more particularly to the grouping and processing of real-time events from multiple sources.

### Description of Related Art

In the field of telemetry and vehicle tracking many devices exist to monitor an interact with real-world events. Vehicles, aircraft, boats and other modes of transportation include an ever expanding of sensors that report location, speed, direction, braking, acceleration as well as a wide variety of statuses of internal engine and vehicle components. As well, information can arrive from a variety of external, networked communication and location based sources.

Information can come in a variety of formats and sizes, at different times, and it is often required that the information be translated into a common format, grouped based on established criteria, or bundled before being received, stored and processed. In order to gain an accurate view of the operation of a vehicle, telemetry events processing devices require that events for any particular device are processed in the exact order they are generated and sent by the given device. In reality, however, events may be received and/or processed out-of-order for a number of reasons, including transmission issues and concurrency issues when events from the same device are processed by multiple processing nodes simultaneously. When events are received and processed out of order it could lead to many data quality problems such as miscalculated trips and distance, mis-evaluated rules and resulting false alerts or notifications or other issues.

Other aspects and features of the present invention will become apparent to those ordinarily skilled in the art upon review of the following description of specific embodiments of the invention in conjunction with the accompanying figures.

### BRIEF SUMMARY OF THE INVENTION

A first major aspect of the invention includes a method of storing telemetry data in a telemetry monitoring device. The method comprises receiving, by a buffer insertion module, a first multiple event data from a first external device. Extracting, by the buffer insertion module, a first event message from the first multiple event data. Storing, by the buffer insertion module, the first event message into a buffer. Receiving, by the buffer insertion module, within a predetermined period, a second multiple event data from a second external device. Extracting, by the buffer insertion module, a second event message from the second multiple event data. Storing, by the buffer insertion module, the second event message into the buffer. Determining, by a buffer processor, that the second event message occurred before the first event message. Receiving, by the buffer processor, the second event message, and transmitting the second event message to a second downstream processor, then receiving, by the buffer processor, the first event message, and transmitting the first event message to a first downstream processor. Wherein, the first downstream processor is the second downstream processor and the buffer processor combines the first event message and the second event message into a multiple event message to transmit the second event message and the first event message to the downstream processor.

In further embodiments, the first external device is the second external device. In other embodiments, the first event message comprises location data.

In further embodiments, the first external device is not the second external device and the first downstream processor is not the second downstream processor.

A second major aspect includes a method of storing telemetry data in a telemetry monitoring device. The method comprises receiving, by a buffer insertion module, a first multiple event data from a first external source. Extracting, by the buffer insertion module, a first plurality of event messages from the first multiple event data. Storing, by the buffer insertion module, the first plurality of event messages into a buffer. Receiving, by the buffer insertion module, within a predetermined period, a second multiple event data from a second external source. Extracting, by the buffer insertion module, a second plurality of event messages from the second multiple event data. Storing, by the buffer insertion module, the second plurality of event messages into the buffer. Sorting into chronological order, by a buffer processor, the first plurality of event messages and the second plurality of event messages. Grouping, by the buffer processor, each of the first plurality of event messages and the second plurality of event messages, by a plurality of external devices that generated each of the first plurality of event messages and the second plurality of event messages. Transmitting the first plurality of event messages and the second plurality of event messages to a plurality of downstream processors.

In further embodiments, the sorting into chronological order is performed based on time stamps associated with each of the first plurality of event messages and each of the second plurality of buffer messages.

In further embodiments, a number of the plurality of downstream processors corresponds to a number of a plurality of external devices.

Other aspects and features of the present invention will become apparent to those ordinarily skilled in the art upon review of the following description of specific embodiments of the invention in conjunction with the accompanying figures.

### BRIEF DESCRIPTION OF THE SEVERAL VIEWS OF THE DRAWING(S)

Embodiments of the present invention will now be described, by way of example only, with reference to the attached Figures, wherein:

FIG. 1 depicts a block diagram of a telemetry system supporting embodiments of the invention;

FIG. 2 depicts a detailed block diagram of a pre-processing services module;

FIG. 3 depicts a detailed block diagram of a snapshot buffering service module;

FIG. 4 depicts a detailed block diagram of examples of ancillary services.

FIG. 5 depicts snapshot processing without grouping or sequencing.

FIG. 6 depicts snapshot processing with grouping and sequencing.

### DETAILED DESCRIPTION OF THE INVENTION

The present invention is directed to managing and maintaining data consistency and order in vehicle telemetry applications and more particularly to preserving the order of event snapshots or message data obtained from a variety of diverse source devices.

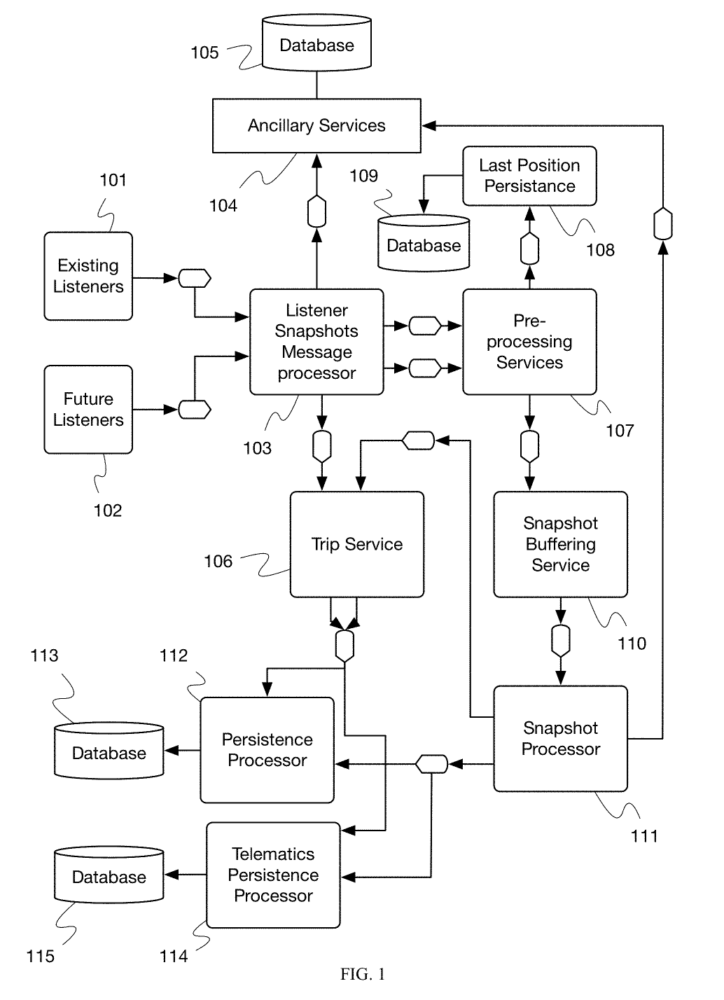

FIG. 1 illustrates a telemetry system incorporating embodiments of the invention. Events, also known as snapshots, are received from external listeners as messages which may be from existing listener devices 101 or future listener devices 102. External listeners gather inputs from a variety of hardware and software data sources external to the system. Event messages may be formatted in a number of different data-interchange formats including JSON (JavaScript Object Notation), XML (eXtensible Markup Language), or other formats, and may contain data regarding a single event or multiple events. Event messages enter queues with a different queue for each data-interchange format, in this example, one for JSON encoded messages and one for XML encoded messages. A Listener Snapshots Message Processor 103 reads messages from the event queues and directs them to a number of destinations for further processing. Some messages may be sent to ancillary services 104 such as a Garmin service 401, a Device Initialization Processing Service 402, a Resource Work Status Update Service 403, an iButton Processing Service 404, and others. These services have access to a first database 105 to store and access data. The Listener Snapshots Message Processor 103 may also send ECM (Engine Control Module) Trip Summary Messages to a Trip Service module 106. Messages may be divided into unified snapshot messages or Last Position (Satellite Failover) messages that are sent to a Pre-Processing Services module 107. Pre-processing involves receiving unified snapshot messages and Last Position messages and adding reverse geocoding messages 205, Point-of-Interest (POI) 206 processing, sensor processing data 207, and other positional data. Reverse geocoded Last Position messages are sent to a Last Position Persistence 108 service and stored in a second database 109. Reverse Geocoded Snapshots messages are sent to a Snapshot Buffering Service 110 that groups messages and reorders them into Sequenced Reverse Geocoded Snapshots messages that are in order of occurrence. The Sequenced Reverse Geocoded Snapshots messages are then sent to the Snapshot Processor 111. Once Sequenced Reverse Geocoded Snapshots messages have been processed by the Snapshot Processor 111 they are send to a variety of destinations. In some cases, they are send to additional ancillary services 104 such as a VIN Update 405 service, a Mail Notification 406 service, or an Alert Notification 407 service. In other cases, the messages are sent to in the form of a Trip Update message to the Trip Service 106. Finally, the Processed Snapshots messages may be sent to either a Persistence Processor 112 or Telematics Persistence 114 processor. The Persistence Processor, which accept processed messages, store them in a third database 113 so that the information is preserved for later analysis. The Telematics Persistence Processor may access a Telematics database 115. The Trip Service module 106 sends Trip Persistence messages and Stop Persistence Messages to the Persistence Processor 112 and Telematics Persistence Processor 114. The various databases may be local or remote and may be a single consolidated database or a plurality of individual databases, in the same of different formats.

Raw telemetry messages are received from a number of hardware devices and sensors. Examples are engine sensors and ECMs, brake sensors and controllers, GPS, cellular positioning information, fuel usage, speed, and others. Embodiments of the invention include a series of services that work together to receive, process and store the telemetry data sent from various hardware devices in the field. Among them, a Raw Message Parsing service is responsible for transforming the raw telemetry data sent from various hardware devices in raw message format into a common format and forward the transformed messages to downstream processing services. The format of the raw messages varies from hardware device to hardware device. For example, with some devices telemetry data is received from the devices directly over a wired or wireless network via TCP or UDP protocol in binary or CSV format. With some other devices, telemetry data is received in JSON format via RESTful APIs provided by the device partner's cloud platform. Once the messages are received from devices or API feeds, they are published as raw messages and consumed by the Raw Message Parsing service. These Raw Message Parsing service will parse the device specific raw messages and transform them into the unified snapshot message format, and then forward the transformed messages to the downstream services for processing.

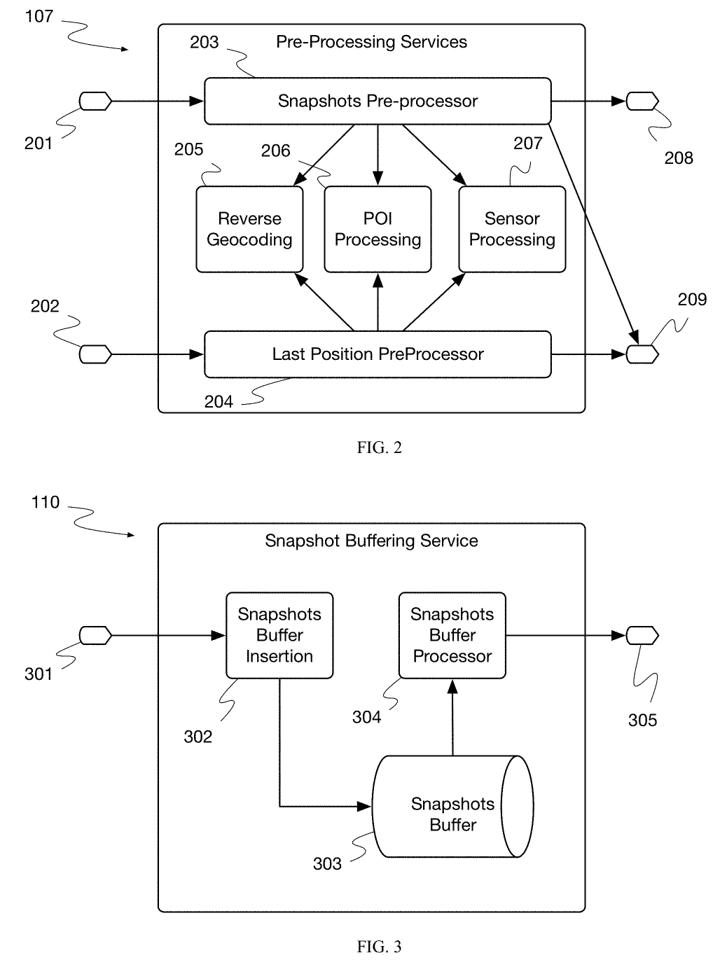

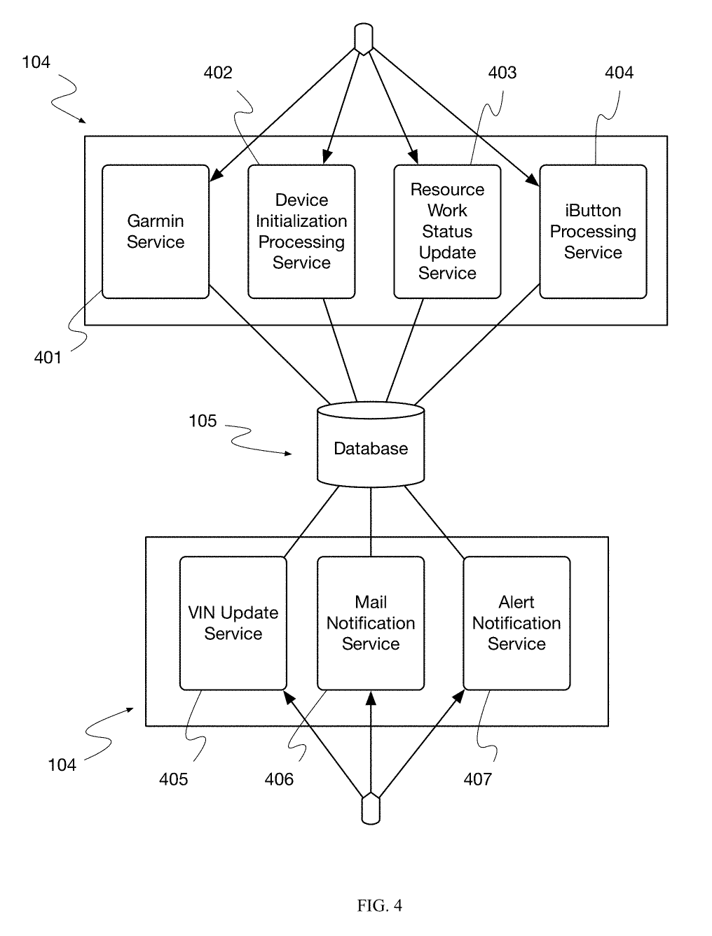

FIG. 2 provides a detailed view of the Pre-Processing Services 107 module. In includes a Snapshots Pre-processor 203 module to receive unified snapshot messages 201 and a Last Position Pre-processor 204 to receive Last Position messages 202. Both processors access Reverse Geocoding 205, POI Processing 206, and location Sensor Processing 207 modules to add or associate location or other information to the received messages. The Pre-Processing Services module 107 outputs Reverse Geocoded Snapshots messages 208 and Reverse Geocoded Last Position messages 209.

The Snapshots Buffering Service 110 addresses Reverse Geocoded Snapshot messages that arrive from a variety of devices and may be out of sequence. Embodiments comprise a mechanism that buffers, sorts and consolidates snapshot events for each device prior to sending them for downstream processing. FIG. 3 provides a detailed view of the Snapshot Buffering Service 110. Reverse Geocoded Snapshots messages 301 are received from the Pre-Processing Services module 107. A Snapshots Buffer Insertion module 302 receives input messages and writes messages to a Snapshots Buffer 303. A Snapshots Buffer Processor 304 reads messages from the Snapshots Buffer 303 and forwards them to the Snapshot Processor 111.

Snapshot event messages are preprocessed and comprise the raw data as well as processed or enriched data. This may include addresses transformed from latitude and longitude coordinates, POI (Point of Interested) data, and sensor information processed from the Unified Snapshot Message and configured in the Pre-Processing Services module 107.

Data typically arrives from external devices in the form of messages that may contain one or more events. The Snapshots Buffer Insertion 302 divides multiple reverse geocoded messages from the original input message into individual snapshot events and insert each message into the snapshot buffer storage.

Snapshots Buffer 303 storage stores buffered messages over a configured buffer window (for example, 1, 5, 15 or 30 seconds) to accommodate the late arrival of out-of-sequence or delayed snapshots. The length of the buffer window, which may be viewed as an “out of order tolerance window”, is the maximum tolerance window that out of order messages are reordered. Messages that arrive out of order but within the configured “out of order tolerance window” will be reordered based on their event timestamp. However, this means that the processing of messages will be delayed by up to this value. The buffer window length is a trade-off between the tolerance window of out of order messages and the latency in the message processing output. Therefore, the value should be tuned based on the actual device data to reduce the number of out of order events and keep the latency low.

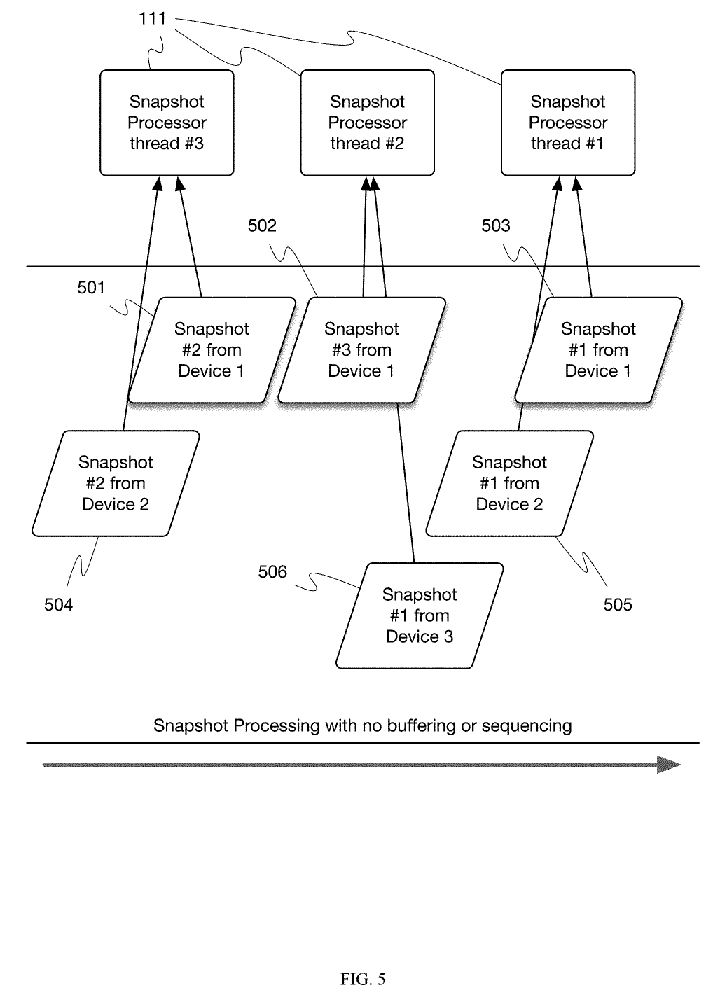

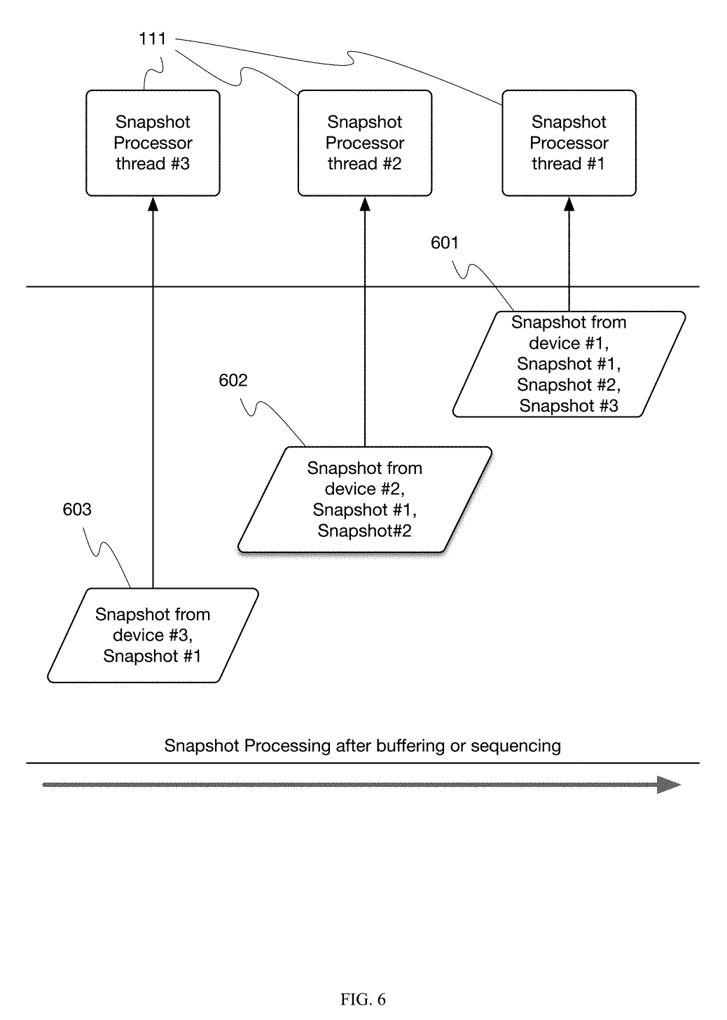

As illustrated in FIG. 5 and FIG. 6, the Snapshots Buffer Processor 302 is responsible for reordering and consolidating a group of snapshot event messages by devices and publishing the consolidated and reordered snapshots to the downstream pipeline. FIG. 5 shows how three snapshots 501 502 503 arrive from device 1 with snapshots 2 501 and 3 502 being out of order. Snapshot 1 arrives first, then Snapshot 3, finally Snapshot 2. Two snapshots 504 505 arrive from device 2 in order. One snapshot 506 arrives from device 3. Three Snapshot Processor threads 111 are running. Thread 1 is created first and processes the first two snapshots to arrive, Snapshot 1 from device 1 503 and snapshot 1 from device 2 505. Thread 2 is created next and processes the next two snapshots to arrive, snapshot 3 from device 1 502 and snapshot 1 from device 3 506. Thread 3 is created next and processes the last two snapshots to arrive, snapshot 2 from device 1 501 and snapshot 2 from device 2 504. FIG. 6 shows how snapshot events are ordered and grouped so that each Snapshot Processor thread 111 processes snapshot events from the same device, in the order that they occurred. The Snapshots Buffer Processor processes messages in batches and may be implemented as scheduling software using Quartz.NET, a .NET based job scheduler. The frequency of the job is specified by a configurable cron schedule used by the Quartz.NET scheduler. In an exemplary embodiment, the configured schedule may be every second. The time may be adjusted based on the target workload. The consolidated snapshot message is preferably in a standard format such as the JSON format. In an exemplary embodiment, the average message size (raw+partially enriched data from the Pre-Processing Service) is approximately 8 kB per snapshot, and a typical consolidated message contains 2 to 4 snapshots.

To provide high throughput, horizontal scalability and data consistency, multiple instances of the Snapshots Buffer Processor may be executed simultaneously. Each instance may be responsible for processing snapshots for a certain subset of events. Also, each instance may be responsible for processing snapshots for a certain subset of clients. Instances may be created and run for a mix of event types and classifications. The scheduler may be configured in a clustering mode to provide high availability and built with controlled job concurrency to ensure that events from a given device will never be processed by two active instances of the Snapshot Buffer Processors simultaneously. For example, if one job instance processing events for a particular group of events is running, the next job instance for the same group will not run even if it's fired based on the 1 second schedule trigger. It will be triggered every second but will not be run until the previous job instance completes its processing. This ensures controlled job concurrency independent of the scheduled job frequency.

In use, events would be captured from a single vehicle or a fleet of vehicles. Snapshot, or event, data as captured in messages from each vehicle outfitted would be sent over a network to a system implementing embodiments of the invention. The data may then be analyzed to gain insight on the operations of a single vehicle, a fleet of vehicles, road conditions, weather conditions, and a variety of other factors. Analysis can reveal information on driver or operator behaviors such as acceleration, breaking, speed, and other factors. This information may be collected across a fleet to generate performance statistics. Analysis may also be used to implement and automate the record of duty logbooks and to enforce restrictions by telling a driver how much longer they can drive or how long they must rest. Collecting data from vibration sensors may be used to identify hazardous road conditions such as potholes, wet weather, icy or snowy weather. Data may be used to determine when preventative or other maintenance or repairs should be performed on vehicles.

Communications between vehicles and the system may happen over any number of networks, mainly wireless networks, and typically over the cellular network. Data can also be transferred through the use of beacons or hotspots deployed at gateways such as when departing or arriving at a loading facility. At beacons or hotspots, short range wireless protocols such as WiFi, Bluetooth or others may be used.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

What is claimed is:

1. A method of storing telemetry data in a telemetry monitoring device, the method comprising:
receiving, by a buffer insertion module, a first multiple event data from a first external device;
extracting, by the buffer insertion module, a first event message from the first multiple event data;
storing, by the buffer insertion module, the first event message into a buffer;
receiving, by the buffer insertion module, within a predetermined period, a second multiple event data from a second external device;
extracting, by the buffer insertion module, a second event message from the second multiple event data;
storing, by the buffer insertion module, the second event message into the buffer;
determining, by a buffer processor, that the second event message occurred before the first event message; and
receiving, by the buffer processor, the second event message, and transmitting the second event message to a second downstream processor, then receiving, by the buffer processor, the first event message, and transmitting the first event message to a first downstream processor.

2. The method of claim 1 wherein, the first downstream processor is the second downstream processor and the buffer processor combines the first event message and the second event message into a multiple event message to transmit the second event message and the first event message to the downstream processor.

3. The method of claim 2 wherein, the first external device is the second external device.

4. The method of claim 1 wherein the first event message comprises location data.

5. The method of claim 2 wherein, the first external device is not the second external device and the first downstream processor is not the second downstream processor.

6. A method of storing telemetry data in a telemetry monitoring device, the method comprising:
receiving, by a buffer insertion module, a first multiple event data from a first external source;
extracting, by the buffer insertion module, a first plurality of event messages from the first multiple event data;
storing, by the buffer insertion module, the first plurality of event messages into a buffer;
receiving, by the buffer insertion module, within a predetermined period, a second multiple event data from a second external source;
extracting, by the buffer insertion module, a second plurality of event messages from the second multiple event data;
storing, by the buffer insertion module, the second plurality of event messages into the buffer;
sorting into chronological order, by a buffer processor, the first plurality of event messages and the second plurality of event messages;
Grouping, by the buffer processor, each of the first plurality of event messages and the second plurality of event messages, by a plurality of external devices that generated each of the first plurality of event messages and the second plurality of event messages; and
transmitting the first plurality of event messages and the second plurality of event messages to a plurality of downstream processors.

7. The method of claim 6 wherein the sorting into chronological order is performed based on time stamps associated with each of the first plurality of event messages and each of the second plurality of buffer messages.

8. The method of claim 6 wherein a number of the plurality of downstream processors corresponds to a number of a plurality of external devices.
